(19) United States
(12) Patent Application Publication
(10) Pub. No.: US 2019/0164556 A1
(43) Pub. Date: May 30, 2019

(54) MASTER-SLAVE PERSONAL DIGITAL ASSISTANT DATA AND KNOWLEDGE EXCHANGE SYSTEM AND METHOD

(71) Applicant: Dean Weber, La Jolla, CA (US)

(72) Inventor: Dean Weber, La Jolla, CA (US)

(21) Appl. No.: 16/206,825

(22) Filed: Nov. 30, 2018

Related U.S. Application Data
(60) Provisional application No. 62/592,833, filed on Nov. 30, 2017.

(51) Int. Cl. G10L 15/34; G06F 9/451; H04L 29/08; G10L 15/26

(52) U.S. Cl. CPC G10L 15/34; G10L 15/26; H04L 67/327; G06F 9/453

(57) ABSTRACT

A communication system is disclosed. The system includes a master personal digital assistant, configured to receive instructions including a first command for a first of a plurality of slave personal digital assistants. The system also includes the plurality of slave personal digital assistants, where each of the slave personal digital assistants is configured to receive data from the master personal digital assistant, and where the master personal digital assistant is configured to process the instructions to identify the first slave personal digital assistant and to transmit first data to the first slave personal assistant. In addition, the first data communicates the first command to the first slave personal assistant.

### CROSS-REFERENCES TO RELATED APPLICATIONS

This application claims the benefit of U.S. Provisional application No. 62/592,833, filed Nov. 30, 2017, titled “MASTER-SLAVE PERSONAL DIGITAL ASSISTANT DATA AND KNOWLEDGE EXCHANGE SYSTEM AND METHOD,” the disclosure of which is incorporated herein by reference.

### FIELD OF THE INVENTION

Aspects of the disclosure relate in general to an artificial intelligence dialogue system that controls conversational interactions with a device and allows for real time updates to dialogue content.

### BACKGROUND OF THE INVENTION

In the industrial design field of human-machine interaction, the user interface (UI) is the space where interactions between humans and machines occur. The interaction allows effective operation and control of the machine from the human end, while the machine simultaneously feeds back information that aids the operators' decision-making process. Examples of this broad concept of user interfaces include the interactive aspects of computer operating systems, and process controls. The design considerations applicable when creating user interfaces are related to or involve such disciplines as ergonomics and psychology.

With the increased use of personal computers and the relative decline in societal awareness of heavy machinery, the term user interface is generally assumed to mean the graphical user interface, while industrial control panel and machinery control design discussions more commonly refer to human-machine interfaces.

Other terms for user interface are man-machine interface (MMI) and when the machine in question is a computer human-computer interface.

### BRIEF SUMMARY OF THE INVENTION

One inventive aspect is a communication system. The system includes a master personal digital assistant, configured to receive instructions including a first command for a first of a plurality of slave personal digital assistants. The system also includes the plurality of slave personal digital assistants, where each of the slave personal digital assistants is configured to receive data from the master personal digital assistant, where the master personal digital assistant is configured to process the instructions to identify the first slave personal digital assistant and to transmit first data to the first slave personal assistant, and where the first data communicates the first command to the first slave personal assistant.

Another inventive aspect is a method of communicating with a communication system. The method includes, with a master personal digital assistant, receiving instructions including a first command for a first of a plurality of slave personal digital assistants, and, with the master personal digital assistant, processing the instructions to identify the first slave personal digital assistant. The method also includes, with the master personal digital assistant, transmitting first data to the first slave personal assistant, where the first data communicates the first command to the first slave personal assistant, and, with the first slave personal digital assistant, receiving first data from the master personal digital assistant.

### BRIEF DESCRIPTION OF THE DRAWINGS

FIG. 1A is a schematic diagram of an embodiment of personal digital assistant system.

FIG. 1B is a schematic diagram of another embodiment of personal digital assistant system.

FIG. 2 is a flowchart diagram of an embodiment of a method performed by a personal digital assistant system.

FIG. 3 is a flowchart diagram of an embodiment of a method of processing instructions performed by a personal digital assistant system.

FIG. 4 is a flowchart diagram of an embodiment of a method of determining a destination slave assistant performed by a personal digital assistant system.

FIG. 5 is a flowchart diagram of an embodiment of a method of processing a command performed by a personal digital assistant system.

FIG. 6 illustrates a configuration for a computer system constructed in accordance with the present disclosure.

FIG. 7 illustrates an example of an interaction between a user and an embodiment of a personal digital assistant system.

FIG. 8 illustrates an example of an interaction between a user and an embodiment of a personal digital assistant system.

### DETAILED DESCRIPTION OF THE INVENTION

Particular embodiments of the invention are illustrated herein in conjunction with the drawings.

Various details are set forth herein as they relate to certain embodiments. However, the invention can also be implemented in ways which are different from those described herein. Modifications can be made to the discussed embodiments by those skilled in the art without departing from the invention. Therefore, the invention is not limited to particular embodiments disclosed herein.

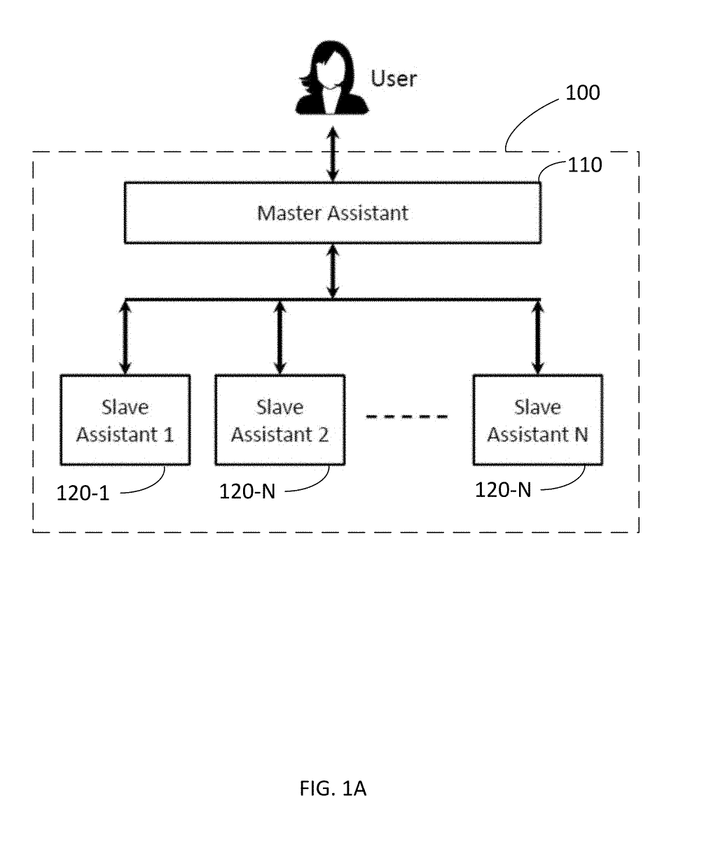

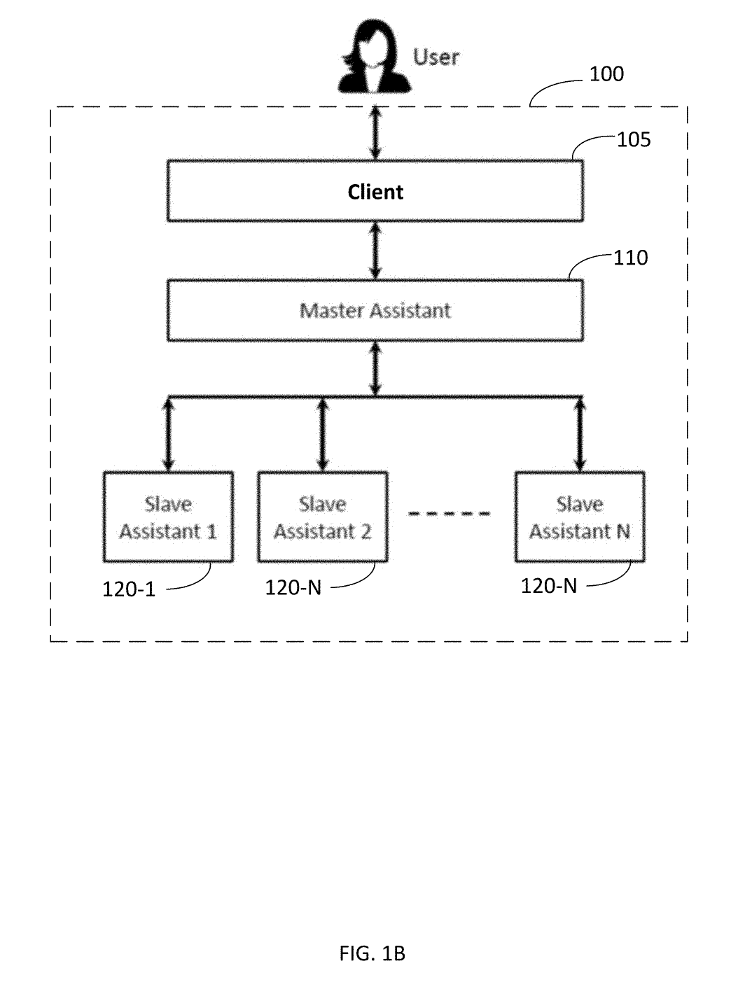

FIGS. 1A and 1B are schematic diagrams of embodiments of personal digital assistant systems 100 and 150.

Aspects of the present disclosure include systems 100 and 150, and methods in which inter-personal digital assistant communications allow information and knowledge exchange between a master digital assistant 110 and a plurality of slave personal digital assistants 120-1-120-N (120). Embodiments allow the user to gain operative access to the slave assistants 120 through the master assistant 110.

The master assistant 110 communicates with the user, for example, via voice and/or text input, and allows for one or multiple user commands within a single user instruction. The master assistant takes the user text input or in the case of voice instructions, converts the user's speech into text and parses the user text request into one or multiple text commands. If the Application Programming Interface (API) of a particular slave assistant 120 supports text input then the master assistant 110 sends the text commands to the particular slave assistant. If the API of the particular slave assistant 120 only supports audio input (ex: Alexa Voice Service) then the master assistant 110 converts the text instructions into audio commands using Text-to-Speech (TTS) synthesis. The TTS audio requests are then sent to the particular slave personal digital assistants for processing.

The master assistant 110 aggregates the information from the slave assistants 120 and presents the collective information back to the user. In addition, the aggregated information is used to train the master assistant 110 to learn from the slave assistants 120 to extend the master assistant's 110 knowledge graph, stored as a knowledge base in a memory, for example of the master assistant 110.

Examples of slave assistants 120 include, but are not limited to, Google Assistant, Amazon Alexa, Apple Siri, IBM Watson and Microsoft Cortana.

In the case of Amazon Alexa, the Alexa Voice Service only supports spoken audio as their primary method of user input. To provide commands to Alexa Voice Service, the master assistant 110 simulates spoken user audio by taking the user's text input instructions or the user's speech-to-text instructions and converts these text instructions to spoken audio commands using TTS synthesis. The master assistant 110 then sends the TTS audio commands to the slave assistants (e.g. Alexa Voice Service). Alexa Voice Service then processes the TTS audio as if it was spoken directly by a user.

Some slave assistants work on a single command at a time which precludes a user from issuing multiple commands within a single instruction. Examples of multiple command instructions include, “set my thermostat to 72 degrees and turn on my office lights”. In the illustrated embodiments, this complex multiple command instruction is properly parsed by the master assistant 110 into multiple individual commands, which are each transmitted to one or more of the slave assistants 120. In the above example, the master assistant 110 is configured to send two commands to either one or two of the slave assistants 120—1) set my thermostat to 72 degrees; 2) turn on my office lights. By way of sending multiple individual commands to the slave assistants 120, the slave assistants 120 handle each command separately. Accordingly, the systems 100 and 150 properly respond to multiple commands within a single instruction from the user to the master assistant 110, because each of the multiple commands of the instruction are handled as individual commands by the slave assistants 120.

System 100 includes master assistant 110 and slave assistants 120, where the master assistant 110 and the slave assistants 120 are communicatively connected via a communications network, such as the Internet, and are configured to communicate using a communications protocol, such as the Internet Protocol (IP). In alternative embodiments other networks and protocols may be used. In this embodiment, master assistant 110 is implemented in a computer system, such as a client, which is local to the user.

For example, the client may include a memory having instructions which, when executed, cause the client to interact with the slave assistants 120 according to the methods and various aspects and principles discussed herein.

System 150 includes a client 105, a master assistant 110, and slave assistants 120, where the client 105, the master assistant 110, and the slave assistants 120 are communicatively connected via a communications network, such as the Internet, and are configured to communicate using a communications protocol, such as the Internet Protocol (IP). In alternative embodiments other networks and protocols may be used. In this embodiment, client 105 is implemented in a computer system which is local to the user, and the master assistant 110 is implemented in a computer system which is remote from the user and from the client 105.

For example, the client 105 may include a memory having instructions which, when executed, cause the client to communicate with the master assistant 110 so as to cause the master assistant 110 to interact with slave assistants 120 according to the methods and various aspects and principles discussed herein.

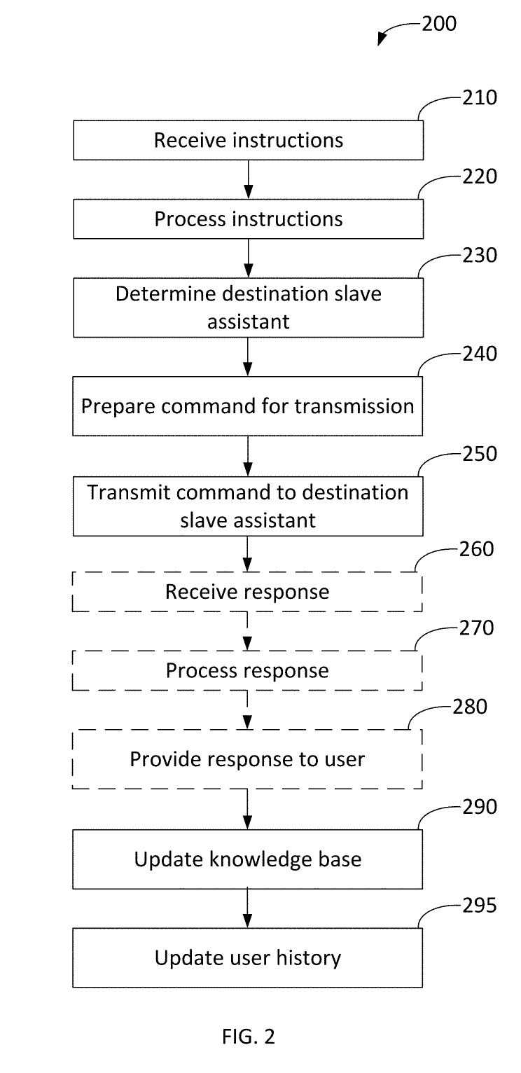

FIG. 2 is a flowchart diagram of an embodiment of a method 200 performed by a personal digital assistant system, such as either of systems 100 and 150.

At 210, the personal digital assistant system receives instructions from a user, for example at a client or at a master assistant. In some embodiments, the instructions are received from the user through an input device, such as a keyboard in the case of text instructions, and a microphone in the case of audio instructions. Alternative instruction formats and corresponding input devices may be used.

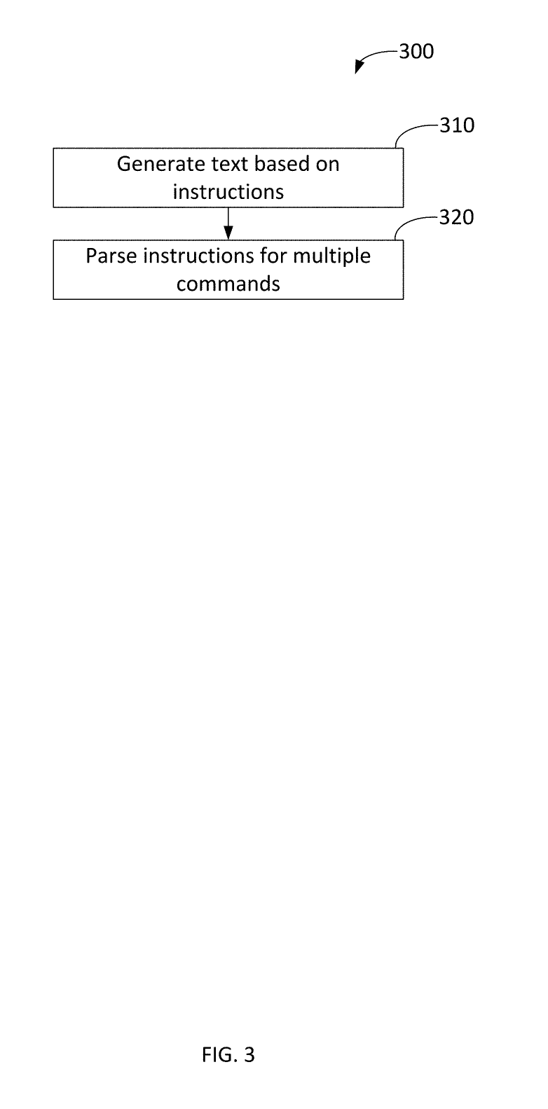

At 220, instructions are processed, for example by the master assistant. For example, the instructions may be processed to extract one or more commands from the received instructions. For example, instructions may include multiple commands, and may include an explicit indication or identification of a particular slave assistant for each of the multiple commands. At 220, the instructions may be processed to generate individual commands for one or more slave assistants, optionally identified for each of the individual commands. An example embodiment is discussed in further detail below with reference to FIG. 3.

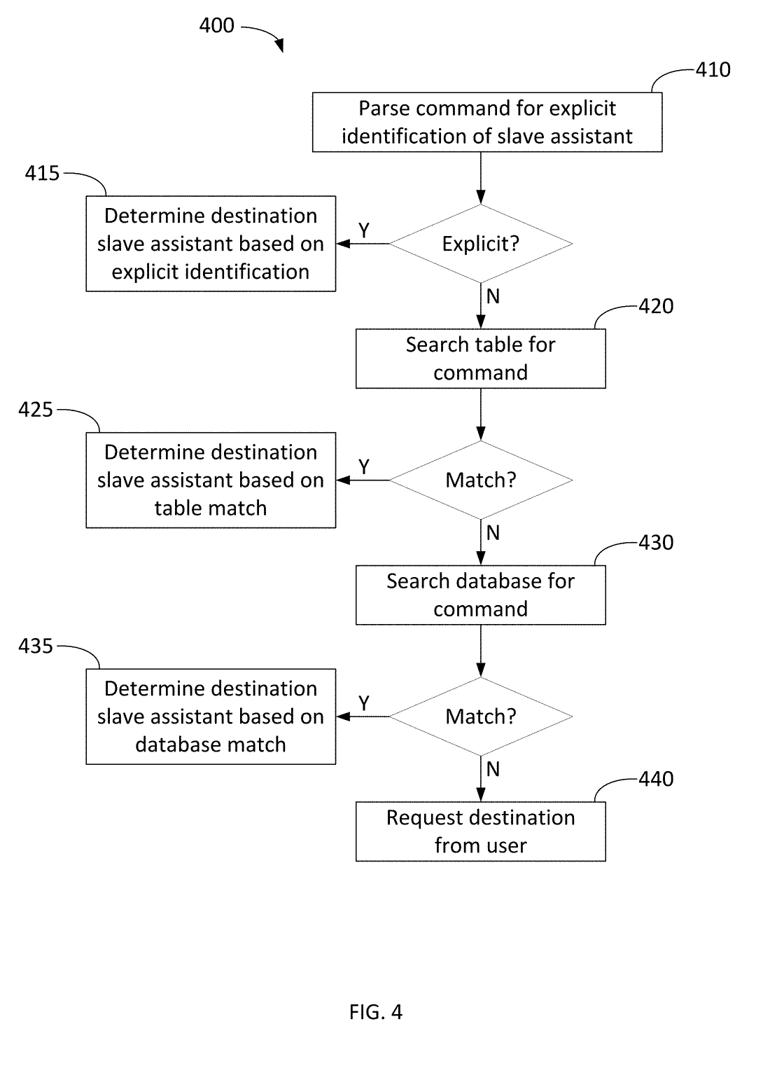

At 230, for each command of the instructions, a destination slave assistant is determined, for example by the master assistant. An example embodiment as discussed in further detail below with reference to FIG. 4.

At 240, each command of the instructions is prepared for transmission to the corresponding destination slave assistant determined at 230. For example, each slave assistant may be configured to receive a particular input format. For example some slave assistants may be configured to receive only audio input, or only text input, or another input. At 240, each command of the instructions is prepared, for example by the master assistant, by generating an input of the format used by the destination slave assistant determined at 230 to which the input is to be transmitted.

At 250, each of the prepared commands is transmitted to the corresponding destination slave assistant determined at 230, for example by the master assistant.

Once that the commands are received at the corresponding destination slave assistants determined at 230, the slave assistants respond to the commands.

In some embodiments, a command for a particular destination slave assistant includes a request. In such embodiments, the particular destination slave assistant generates a response based on the request, and transmits the response, for example to the master assistant.

At 270, the response is processed, for example by the master assistant. For example, the response may include a reference to audio data, which may be retreived so that the audio data may be presented to the user. In some embodiments, the audio data is retrieved and converted to text data using a speech to text conversion process.

Additionally or alternatively, the response may include text data, such as JSON data, which may be extracted from the response so that the text data may be presented to the user. In some embodiments, the text data is extracted and is converted to audio data using a text to speech (TTS) conversion process.

At 280, the data of the response is presented to the user, for example on a display in the case of text data, or using a speaker in the case of audio data.

At 290, the knowledge base of the system, for example stored at the master assistant, is updated, for example by storing data corresponding with various aspects of the instructions from the user, the commands, the destination slave assistants, and any responses received from the destination slave assistants. The stored data corresponding with the various aspects of each of the instructions from the user, the commands, the destination slave assistants, and any responses received from the destination slave assistants is stored with associative links indicating that the various aspects are associated with one another.

At 295, the user history, for example stored at the user client, is updated, for example by storing data corresponding with various aspects of the instructions from the user, the commands, the destination slave assistants, and any responses received from the destination slave assistants. The stored data corresponding with the various aspects of each of the instructions from the user, the commands, the destination slave assistants, and any responses received from the destination slave assistants is stored with associative links indicating that the various aspects are associated with one another.

FIG. 3 is a flowchart diagram of an embodiment of a method of processing instructions performed by a personal digital assistant system, and may be performed, for example, as part of 220 of method 200 of FIG. 2. In this embodiment, the instructions are received from the user are audio format and include multiple commands.

At 310, using a speech to text conversion process, text is generated based on the received audio instructions, for example by a master assistant.

At 320, the generated text is parsed so as to separate each of the multiple commands of the instructions, for example by the master assistant. For example, using techniques discussed in any of U.S. Pat. Nos. 6,434,524, 6,532,444, and 6,499,013 may be used. Each of U.S. Pat. Nos. 6,434,524, 6,532,444, and 6,499,013 are incorporated herein in their entirety for all purposes.

In addition, at 320, each of the separate commands of the audio instructions is associated with any slave assistant explicitly identified in the audio instructions as being the intended destination therefor.

FIG. 4 is a flowchart diagram of an embodiment of a method 400 of determining a destination slave assistant performed by a personal digital assistant system, and may be performed, for example, as part of 230 of method 200 of FIG. 2 for each of multiple commands to determine which of multiple slave assistants each of the commands is to be transmitted to.

At 410, the command for which a destination slave assistant is to be determined is parsed to determine whether an explicit indication of the destination slave assistant is included with the command.

If an explicit indication of the destination slave assistant is included with the command, at 415, the explicitly indicated destination slave assistant is identified as the destination slave assistant for the command.

In addition, in some embodiments, at 415, a database of commands is updated to associate the identified destination slave assistant with the command so that should the same or similar command be issued in the future without an explicit indication of the destination slave assistant, the database may be accessed to determine the identified destination slave assistant as the destination slave assistant for the command issued in the future.

If an explicit indication of the destination slave assistant is not included with the command, at 420, a table of commands or command types is referenced or searched to determine whether the command is associated with the commands or command types of the table.

For example, prior to issuing the instructions, the user may provide information to the system for generating and populating the table. For example, the user may provide information indicating that all commands related to music are to be directed to the Google Assistant slave assistant. Similarly, the user may provide information indicating that each time the specific command “play rock and roll music” is received, it should be directed to the Google slave assistant. As another example, all commands related to shopping may assigned to be directed to the Alexa slave assistant. For example, “add milk to my shopping list” will be directed to the Alexa slave assistant.

If the command of the instructions is associated with a command or command type of the table, at 425, the slave assistant associated with the command or command type is identified as the destination slave assistant for the command.

If the command of the instructions is not associated with the command or command type of the table, at 430, a database of previously transmitted commands is referenced or searched to determine whether the command of the instructions is associated with the commands or command types of the database.

For example, prior to issuing the instructions, the user may have previously issued instructions having a command identical or similar to the command of the instructions and having an explicitly identified destination slave assistant. In such cases, at 430, the search of the database reveals that the command of the instructions is associated with a command or command type of the database, and at 435, the slave assistant associated with the associated command or command type is identified as the destination slave assistant for the command of the instructions.

If the search of the database reveals that the command of the instructions is not associated with a command or command type of the database, at 440, a request to the user for an explicit indication of the slave assistant for the command is issued, for example by the master assistant.

In alternative embodiments, in addition to or instead of the table and database discussed with reference to the method 400, an artificial intelligence (AI) engine may generate a table to be referenced or searched to identify and determine a destination slave assistant. For example, the AI engine may monitor commands transmitted to the slave assistants, and learn which slave assistants receive which commands or command types.

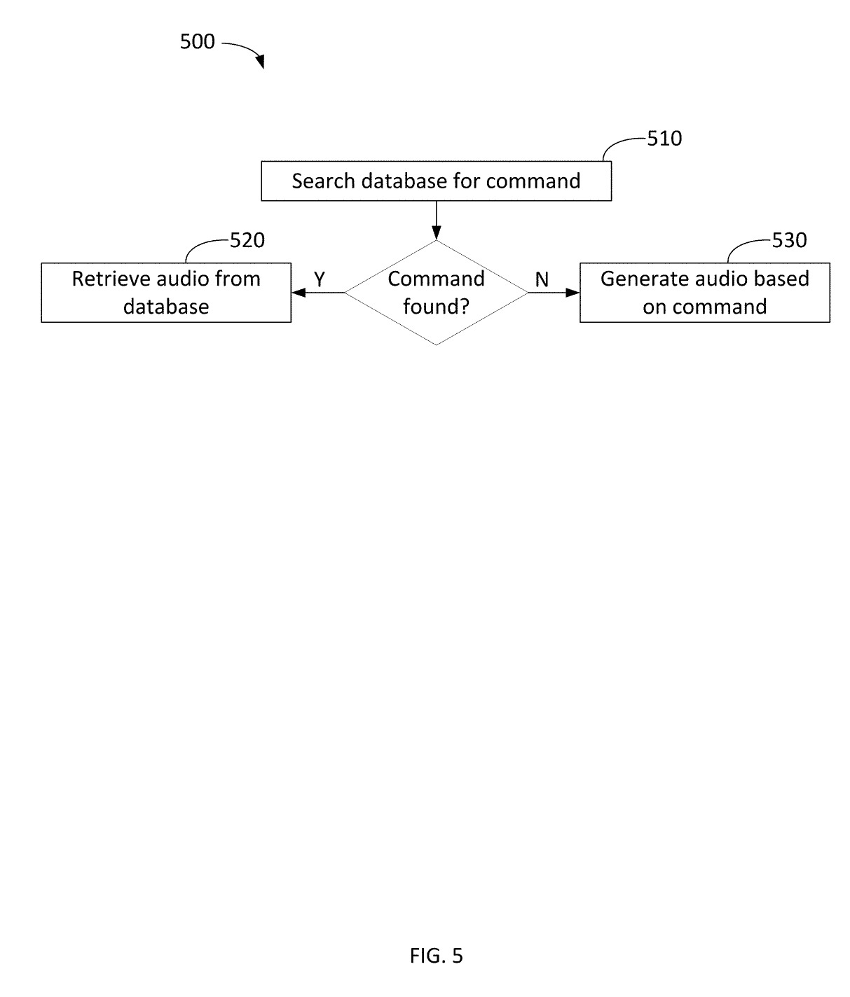

FIG. 5 is a flowchart diagram of an embodiment of a method 500 of processing a command performed by a personal digital assistant system, and may be performed, for example, as part of 240 of method 200 of FIG. 2 for each of multiple commands to prepare the command for transmission to a destination slave assistant. In the method 500, the destination slave assistant requires commands the in an audio format.

At 510, a database of previously transmitted commands is referenced or searched to determine whether the command of the instructions is identical to a command of the database.

For example, prior to issuing the instructions, the user may have previously issued instructions having a command identical to the command of the instructions and which was transmitted to the identified destination slave assistant for the command of the instructions. In such cases, at 510, the search of the database reveals that the command of the instructions is identical with the previously issued command, and at 520, the audio format of the identical previously transmitted command is accessed as the audio file to be transmitted for the command of the instructions.

If the search of the database reveals that the command of the instructions is not associated with a previously transmitted command of the database, at 530, audio data for the command of the instructions is generated, for example using a text to speech process, for example by the master assistant.

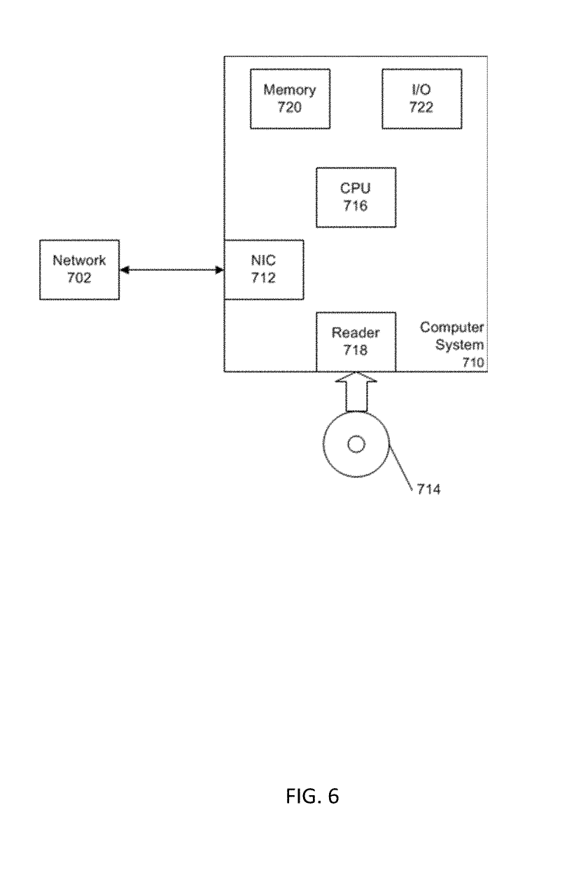

FIG. 6 illustrates a configuration for a computer system 710 constructed in accordance with the present disclosure. The computer system 710 can comprise a system such as a personal computer or server computer or the like. The computer system 710 may include a network communication interface 712 that permits communications with a network 702. The network interface can comprise a network interface card (NIC). The computer system 710 can execute instructions to provide a computer system which performs various aspects and principles of the methods and features described herein.

The computer system 710 includes a central processor unit 716 (CPU) and a program product reader 718 for receiving a program product media and reading program instructions recorded thereon, where the instructions, when executed by the computer cause the computer to perform various aspects and principles of the methods and features described herein. The computer system also includes associated memory 720 and input/output facilities 722, such as a display for output and a keyboard and/or mouse for input. The processor 716 of the computer system 710 can receive program instructions into the program memory of the processor. The program instructions can be received directly, such as by flashing EEPROM of the processor, or can be received through the network interface 712, such as by download from a connected device or over a WAN or LAN network communication. If desired, the program instructions can be stored on a computer program product 714 that is read by the computer system 710 so that the program instructions can thereafter executed. That is, the program product 714 is for use in a system such as the computer system 710, wherein the program product comprises a tangible, non-transitory recordable media containing a program of computer-readable instructions that are executable by the device processor 704 to perform the operations described herein. The program product 714 can comprise, for example, optical program media such as CD or DVD data discs, or flash memory drives, or external memory stores, or floppy magnetic disks, and the like.

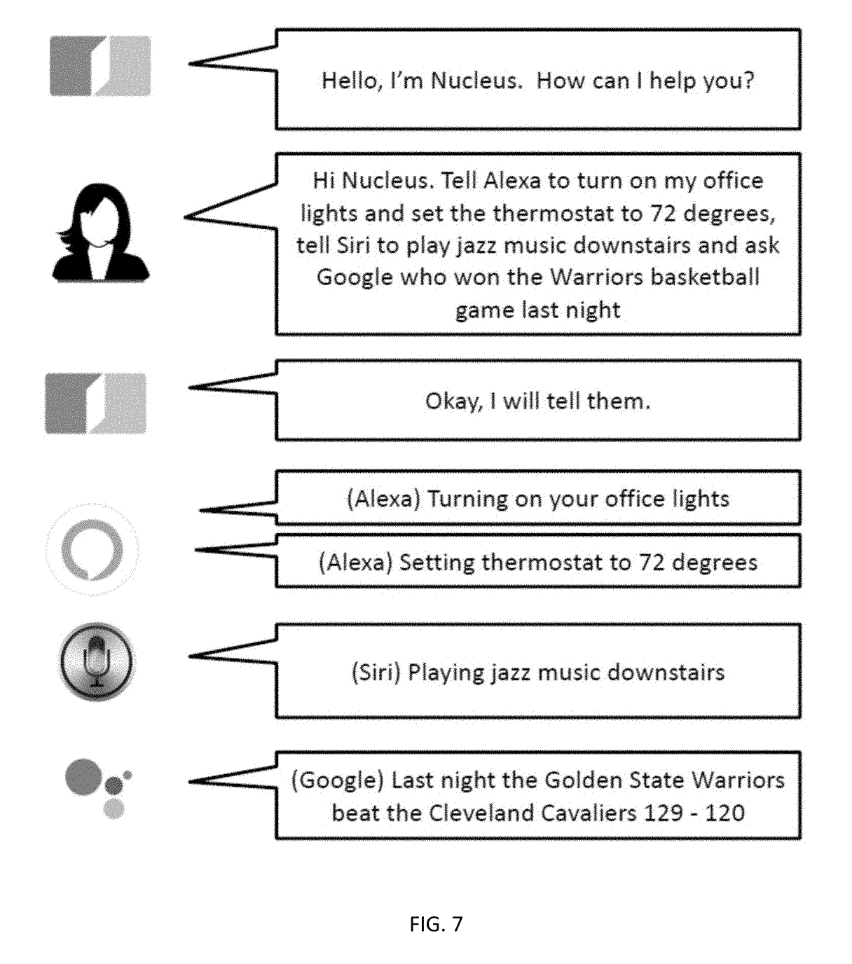

FIG. 7 illustrates an example of an interaction between a user and an embodiment of a personal digital assistant system.

In the example, the personal digital assistant system, called Nucleus, receives instructions from the user. As indicated, the instructions, “Tell Alexa to turn on my office lights and set the thermostat to 72°, tell Siri to play jazz music downstairs and ask Google who won the Warriors basketball game last night,” includes multiple commands and is for multiple slave assistants, Alexa, Siri, and Google. In this example, each of the commands include an explicit indication of which slave assistant is to receive each command.

In response to receiving the instructions, according to principles and aspects discussed elsewhere herein, Nucleus processes the instructions, prepares commands for each of Alexa, Siri, and Google, and transmits the respective commands to each of Alexa, Siri, and Google. According to principles and aspects discussed elsewhere herein, each of Alexa, Siri, and Google receive the commands from Nucleus, process the commands, take actions according to the commands, and provide responses where commanded.

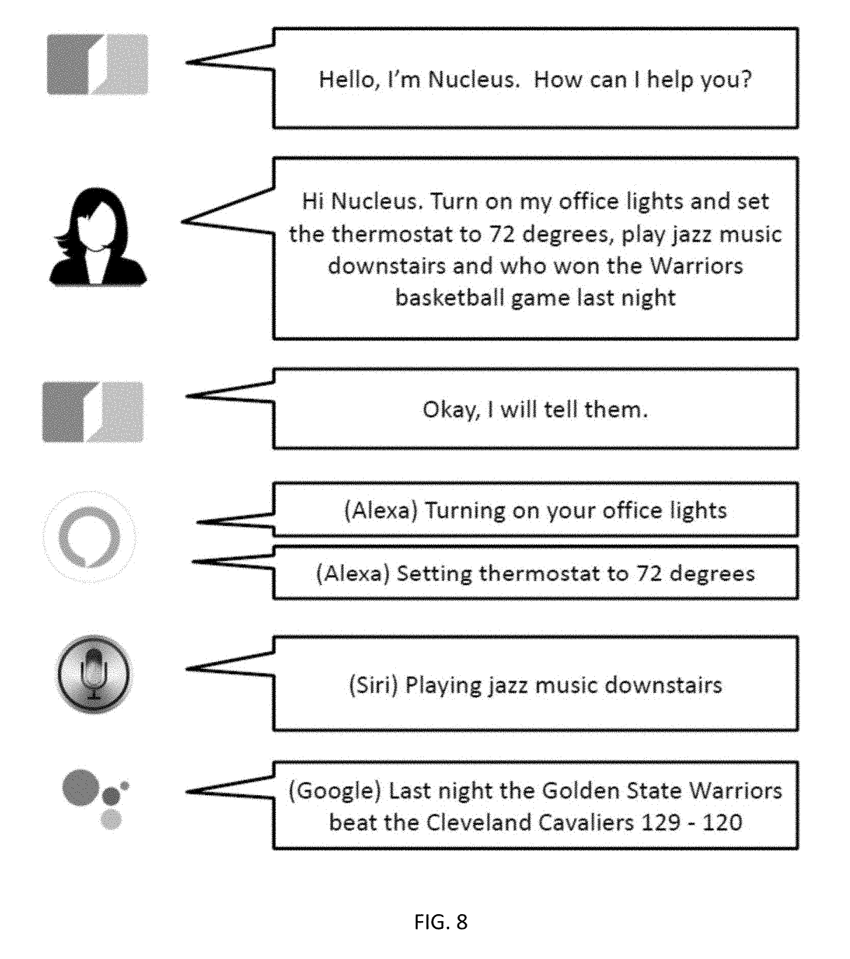

FIG. 8 illustrates another example of an interaction between a user and an embodiment of a personal digital assistant system.

In the example, the personal digital assistant system, called Nucleus, receives instructions from the user. As indicated, the instructions, “Turn on my office lights and set the thermostat to 72°, play jazz music downstairs and who won the Warriors basketball game last night,” includes multiple commands and is for multiple slave assistants, Alexa, Siri, and Google. In this example, the instructions do not include an explicit indication of which slave assistant is to receive each command.

In response to receiving the instructions, according to principles and aspects discussed elsewhere herein, Nucleus processes the instructions, determines which slave assistant is to receive each command, prepares the commands for each of Alexa, Siri, and Google, and transmits the respective commands to each of Alexa, Siri, and Google. According to principles and aspects discussed elsewhere herein, each of Alexa, Siri, and Google receive the commands from Nucleus, process the commands, take actions according to the commands, and provide responses where commanded.

The present invention has been described above in terms of presently preferred embodiments so that an understanding of the present invention can be conveyed. There are, however, many configurations for network devices and management systems not specifically described herein but with which the present invention is applicable. The present invention should therefore not be seen as limited to the particular embodiments described herein, but rather, it should be understood that the present invention has wide applicability with respect to network devices and management systems generally. All modifications, variations, or equivalent arrangements and implementations that are within the scope of the attached claims should therefore be considered within the scope of the invention.

Though the present invention is disclosed by way of specific embodiments as described above, those embodiments are not intended to limit the present invention. Based on the methods and the technical aspects disclosed above, variations and changes may be made to the presented embodiments by those skilled in the art without departing from the spirit and the scope of the present invention.

What is claimed is:

1. A communication system, comprising:
a master personal digital assistant, configured to receive instructions comprising a first command for a first of a plurality of slave personal digital assistants; and
the plurality of slave personal digital assistants, wherein each of the slave personal digital assistants is configured to receive data from the master personal digital assistant,
wherein the master personal digital assistant is configured to process the instructions to identify the first slave personal digital assistant and to transmit first data to the first slave personal assistant, wherein the first data communicates the first command to the first slave personal assistant.

2. The system of claim 1, wherein the instructions comprise an explicit indication identifying a particular one of the slave personal digital assistants to which at least one of the commands is to be transmitted, and wherein the master personal digital assistant is configured to identify the first slave personal digital assistant to be transmitted to based on the explicit indication.

3. The system of claim 1, wherein the master personal digital assistant is configured to identify the first slave personal digital assistant based on the master personal digital assistant having previously transmitted a command similar or identical to the first command to the first slave personal digital assistant.

4. The system of claim 1, wherein the instructions further comprise a second command for a second of the plurality of slave personal digital assistants, and wherein the master personal digital assistant is further configured to process the instructions to identify the second slave personal digital assistant and to transmit second data to the second slave personal assistant, wherein the second data communicates the second command to the second slave personal assistant.

5. The system of claim 1, wherein the received instructions have an audio format, and wherein processing the instructions comprises converting the instructions from the audio format to a text format and parsing the text of the instructions in the text format.

6. The system of claim 1, wherein the master personal digital assistant is further configured to generate the first data, wherein generating the first data comprises converting text corresponding with the first command to an audio format.

7. The system of claim 1, wherein the master personal digital assistant is further configured to retrieve the first data from a database, wherein the first data is retrieved from the database based on the first data being associated with the first command in the database.

8. The system of claim 1, wherein the first data comprises a request, wherein first slave personal digital assistant is configured to transmit a response based on the request to the master personal digital assistant, wherein the master personal digital assistant is configured to receive the response, and to present data of the response to the user.

9. The system of claim 8, wherein the response comprises a reference to audio data, and wherein the master personal digital assistant is configured to retrieve the audio data and to present the audio data to the user by playing the audio data using a speaker.

10. The system of claim 8, wherein the response comprises text data, and wherein the master personal digital assistant is configured to present the text data to the user by displaying information based on the text data on a display.

11. A method of communicating with a communication system, the method comprising:
with a master personal digital assistant, receiving instructions comprising a first command for a first of a plurality of slave personal digital assistants;
with the master personal digital assistant, processing the instructions to identify the first slave personal digital assistant;
with the master personal digital assistant, transmitting first data to the first slave personal assistant, wherein the first data communicates the first command to the first slave personal assistant; and
with the first slave personal digital assistant, receiving first data from the master personal digital assistant.

12. The method of claim 11, wherein the instructions comprise an explicit indication identifying a particular one of the slave personal digital assistants to which at least one of the commands is to be transmitted, and wherein the method further comprises, with the master personal digital assistant identifying the first slave personal digital assistant to be transmitted to based on the explicit indication.

13. The method of claim 11, further comprising, with the master personal digital assistant identifying the first slave personal digital assistant based on the master personal digital assistant having previously transmitted a command similar or identical to the first command to the first slave personal digital assistant.

14. The method of claim 11, wherein the instructions further comprise a second command for a second of the plurality of slave personal digital assistants, and wherein the method further comprises, with the master personal digital assistant processing the instructions to identify the second slave personal digital assistant and transmitting second data to the second slave personal assistant, wherein the second data communicates the second command to the second slave personal assistant.

15. The method of claim 11, wherein the received instructions have an audio format, and wherein processing the instructions comprises converting the instructions from the audio format to a text format and parsing the text of the instructions in the text format.

16. The method of claim 11, wherein the method further comprises, with the master personal digital assistant, generating the first data, wherein generating the first data comprises converting text corresponding with the first command to an audio format.

17. The method of claim 11, wherein the method further comprises, with the master personal digital assistant retrieving the first data from a database, wherein the first data is retrieved from the database based on the first data being associated with the first command in the database.

18. The method of claim 11, wherein the first data comprises a request, wherein the method further comprises:
with the first slave personal digital assistant, transmitting a response based on the request to the master personal digital assistant, and
with the master personal digital assistant receiving the response, and presenting data of the response to the user.

19. The method of claim 11, wherein the response comprises a reference to audio data, and wherein the method further comprises, with the master personal digital assistant retrieving the audio data and presenting the audio data to the user by playing the audio data using a speaker.

20. The method of claim 11, wherein the response comprises text data, and wherein the method further comprises, with the master personal digital assistant presenting the text data to the user by displaying information based on the text data on a display.
